(19) United States
(12) Patent Application Publication
(10) Pub. No.: US 2024/0357696 A1
(43) Pub. Date: Oct. 24, 2024

(54) METHOD AND APPARATUS FOR WAKING TERMINAL FOR MULTICAST SESSION ACTIVATION

(71) Applicant: Samsung Electronics Co., Ltd., Suwon-si, Gyeonggi-do (KR)

(72) Inventor: Youngkyo BAEK, Suwon-si (KR)

(21) Appl. No.: 18/685,424

(22) PCT Filed: Sep. 30, 2022
(86) PCT No.: PCT/KR2022/014811

§ 371 Date: Feb. 21, 2024

(30) Foreign Application Priority Data
Sep. 30, 2021 (KR) 10-2021-0130321

(51) Int. Cl. H04W 76/27; H04W 68/00; H04W 76/40

(52) U.S. Cl. CPC H04W 76/27; H04W 68/005; H04W 76/40

(57) ABSTRACT

The present disclosure, pertaining to a 5G or 6G communication system for supporting a higher data transmission rate, provides a method for operating an apparatus having an access and management function (AMF) for waking a terminal to activate a multicast/broadcast service (MBS) session in a mobile communication system.

### CROSS-REFERENCE TO RELATED APPLICATION(S)

This application is a U.S. National Stage application under 35 U.S.C. § 371 of an International application number PCT/KR2022/014811, filed on Sep. 30, 2022, which is based on and claims priority of a Korean patent application number 10-2021-0130321, filed on Sep. 30, 2021, in the Korean Intellectual Property Office, the disclosure of which is incorporated by reference herein in its entirety.

### TECHNICAL FIELD

The disclosure relates to a method and apparatus for transmitting multicast and/or broadcast data to a terminal and, more particularly, to a method and apparatus for transmitting multicast and/or broadcast data to a terminal in a 5G network.

### BACKGROUND ART

5G mobile communication technology defines a wide frequency band to enable fast transmission speed and new services, and can be implemented not only in a sub-6 GHz frequency band (“sub 6 GHz”) such as 3.5 GHz but also in an ultra-high frequency band (“above 6 GHz”) called mm Wave such as 28 GHz or 39 GHz. In addition, 6G mobile communication technology called “beyond 5G system” is being considered for implementation in a terahertz (THz) band (e.g., band of 95 GHz to 3 THz) to achieve transmission speed that is 50 times faster and ultra-low latency that is reduced to 1/10 compared with 5G mobile communication technology.

In the early days of 5G mobile communication technology, to meet service support and performance requirements for enhanced mobile broadband (eMBB), ultra-reliable and low-latency communication (URLLC), and massive machine-type communications (mMTC), standardization has been carried out regarding beamforming for mitigating the pathloss of radio waves and increasing the propagation distance thereof in the mm Wave band, massive MIMO, support of various numerology for efficient use of ultra-high frequency resources (e.g., operating multiple subcarrier spacings), dynamic operations on slot formats, initial access schemes to support multi-beam transmission and broadband, definition and operation of bandwidth parts (BWP), new channel coding schemes such as low density parity check (LDPC) codes for large-capacity data transmission and polar codes for reliable transmission of control information, L2 pre-processing, and network slicing for providing a dedicated network specialized for a specific service.

Currently, discussions are underway to improve 5G mobile communication technology and enhance performance thereof in consideration of the services that the 5G mobile communication technology has initially intended to support, and physical layer standardization is in progress for technologies such as V2X (Vehicle-to-Everything) that aims to help a self-driving vehicle to make driving decisions based on its own location and status information transmitted by vehicles and to increase user convenience, new radio unlicensed (NR-U) for the purpose of system operation that meets various regulatory requirements in unlicensed bands, low power consumption scheme for NR terminals (UE power saving), non-terrestrial network (NTN) as direct terminal-satellite communication to secure coverage in an area where communication with a terrestrial network is not possible, and positioning.

In addition, standardization in radio interface architecture/protocol is in progress for technologies such as intelligent factories (industrial Internet of things, IIoT) for new service support through linkage and convergence with other industries, integrated access and backhaul (IAB) that provides nodes for network service area extension by integrating and supporting wireless backhaul links and access links, mobility enhancement including conditional handover and dual active protocol stack (DAPS) handover, 2-step random access (2-step RACH for NR) that simplifies the random access procedure; and standardization in system architecture/service is also in progress for the 5G baseline architecture (e.g., service based architecture, service based interface) for integrating network functions virtualization (NFV) and software defined networking (SDN) technologies, and mobile edge computing (MEC) where the terminal receives a service based on its location.

When such a 5G mobile communication system is commercialized, connected devices whose number is explosively increasing will be connected to the communication networks; accordingly, it is expected that enhancement in function and performance of the 5G mobile communication system and the integrated operation of the connected devices will be required. To this end, new research will be conducted regarding 5G performance improvement and complexity reduction, AI service support, metaverse service support, and drone communication by utilizing extended reality (XR) for efficiently supporting augmented reality (AR), virtual reality (VR), and mixed reality (MR), artificial intelligence (AI), and machine learning (ML).

Further, such advancement of 5G mobile communication systems will be the basis for the development of technologies such as new waveforms for ensuring coverage in the terahertz band of 6G mobile communication technology, full dimensional MIMO (FD-MIMO), multi-antenna transmission such as array antenna or large scale antenna, metamaterial-based lenses and antennas for improved coverage of terahertz band signals, high-dimensional spatial multiplexing using orbital angular momentum (OAM), reconfigurable intelligent surface (RIS) technique, full duplex technique to improve frequency efficiency and system network of 6G mobile communication technology, satellites, AI-based communication that utilizes artificial intelligence (AI) from the design stage and internalizes end-to-end AI support functions to realize system optimization, and next-generation distributed computing that realizes services whose complexity exceeds the limit of terminal computing capabilities by utilizing ultra-high-performance communication and computing resources.

Meanwhile, to transmit the same data to multiple terminals located in a specific region in a mobile communication network, data can be transmitted to each terminal by unicast. Further, in some cases, data may be provided through multicast to transmit the same data to multiple terminals in a mobile communication network for resource efficiency.

At this time, for a specific multicast service, when multicast service traffic does not occur for a certain period of time, or when the application server intends to temporarily stop the multicast service, it is possible to save resources by disabling multicast sessions corresponding to the multicast service. However, if the application server intends to activate the multicast service again, or if corresponding multicast service traffic occurs again, a scheme is needed to activate the multicast session. In particular, when terminals using the multicast service are in idle state, a scheme is needed to wake up the terminals.

### DISCLOSURE OF INVENTION

### Technical Problem

Accordingly, the disclosure provides a method and apparatus for providing a multicast service to a terminal in idle state in a mobile communication system.

In addition, the disclosure provides a method and apparatus that enable a terminal having received a multicast service and transitioned to an idle state to efficiently resume the multicast service in a mobile communication system.

Further, the disclosure provides a method and apparatus that wake up, when a terminal receiving a multicast service transitions to an idle state, the terminal in a mobile communication system.

### Solution to Problem

A method according to an embodiment of the disclosure, as an operation method of an access and management function (AMF) entity for waking up terminals to activate a multicast/broadcast service (MBS) session in a mobile communication system, may include: receiving a first request message, which includes a list of terminals in idle state and a temporary mobile terminal group identity (TMGI) and requests waking-up of the terminals in idle state, from a session management function (SMF) entity; transmitting a paging request message including the TMGI to at least one MBS capable base station; starting a delay timer for individual paging; receiving a service request message from at least one of the terminals in idle state via the at least one MBS capable base station; updating the list of terminals in idle state by excluding a terminal having transmitted the service request message; and transmitting a paging request message including at least a portion of the updated list of terminals in idle state to at least one non-MBS capable base station.

### Advantageous Effects of Invention

According to the disclosure, when activating a deactivated multicast session for a terminal utilizing a multicast service in a 5GS (5G system), the terminal remaining in idle state can be efficiently woken up to use the multicast service smoothly.

### BRIEF DESCRIPTION OF DRAWINGS

FIG. 1 illustrates a 5GS architecture for multicast services according to an embodiment of the disclosure.

FIG. 2 illustrates an existing procedure for waking up a UE in idle state in the process of activating a multicast session.

FIG. 3 is an example diagram illustrating a stepwise paging procedure as a method for waking up a UE in idle state in the process of activating a multicast session according to an embodiment of the disclosure.

FIG. 4 is an example diagram illustrating a procedure of retrying stepwise paging as a method of waking up a UE in idle state in the process of activating a multicast session according to an embodiment of the disclosure.

FIG. 5 is an example diagram illustrating a procedure of determining a paging scheme in the RAN as a method of waking up a UE in idle state in the process of activating a multicast session according to an embodiment of the disclosure.

FIG. 6 is a block diagram of a UE according to an embodiment of the

disclosure.

FIG. 7 is a block diagram of an NF according to an embodiment of the disclosure.

### MODE FOR THE INVENTION

Hereinafter, the operating principle of the present disclosure will be described in detail with reference to the accompanying drawings. In explaining the disclosure below, descriptions of well-known functions and structures incorporated herein may be omitted to avoid obscuring the subject matter of the disclosure. The terms described below are defined in consideration of their functions in the disclosure, and these may vary depending on the intention of the user, the operator, or the custom. Hence, their meanings should be determined based on the overall contents of this specification.

Those terms used in the following description for identifying an access node, indicating a network entity (NF), indicating a message, indicating an interface between NFs, and indicating various identification information are taken as illustration for ease of description. Accordingly, the disclosure is not limited by the terms to be described later, and other terms referring to objects having an equivalent technical meaning may be used.

First, a brief description is given of a multicast service. To provide a multicast service, a 5G system (5GS) may receive multicast service data from an AF or content provider and deliver it to the NG-RAN, thereby transmitting the multicast service data to UEs that have subscribed to the multicast service. There are two ways to deliver multicast data from the 5G core network to the NG radio access network (NG-RAN) being a base station of the 5G network: shared delivery and individual delivery. When the NG-RAN has a multicast/broadcast service (MBS) capability, it is possible to transmit the multicast service data from a multicast/broadcast user plane function (MB-UPF) providing a multicast/broadcast service to the NG-RAN through a tunnel for shared delivery. On the other hand, when the NG-RAN does not have an MBS capability, since shared delivery is not applicable, as individual delivery, multicast service data can be transmitted to the UE through a tunnel from the corresponding UPF to the NG-RAN via an associated protocol data unit (PDU) session for MBS data received through the MB-UPF.

When the multicast session for a multicast service is deactivated, the tunnel for shared delivery and the tunnel for individual delivery may be deactivated or released, and UEs having received the multicast service may also transition to the idle state.

Therefore, a method is needed to wake up a UE in idle state. As a scheme to wake up UEs in idle state, individual paging may be performed for each UE. However, in a case where there are many UEs receiving a multicast service, if individual paging is performed for all UEs receiving the multicast service by all base stations in the service area providing the MBS, a large amount of paging resources are used in a short period of time. This is inefficient as it affects services for other UEs. For example, because individual paging must be performed for many UEs, a lack of paging resources may occur or interference due to individual paging may occur. To prevent this problem, a base station that supports the MBS may attempt group paging using a temporary mobile group identity (TMGI) or MBS session ID. However, since a UE in idle mode may be located in a base station that does not support the MBS within the multicast service area, there is a problem in that individual paging may also be attempted for this.

Accordingly, to wake up UEs in idle mode in a mobile communication network, there is a need for a scheme to apply group paging and individual paging in a suitable way. In the following embodiments, these problems and solutions will be described.

For convenience of description below, terms and names defined in the standards for 5G systems are utilized. However, the disclosure is not limited by the above terms and names, and may be equally applied to systems conforming to other standards.

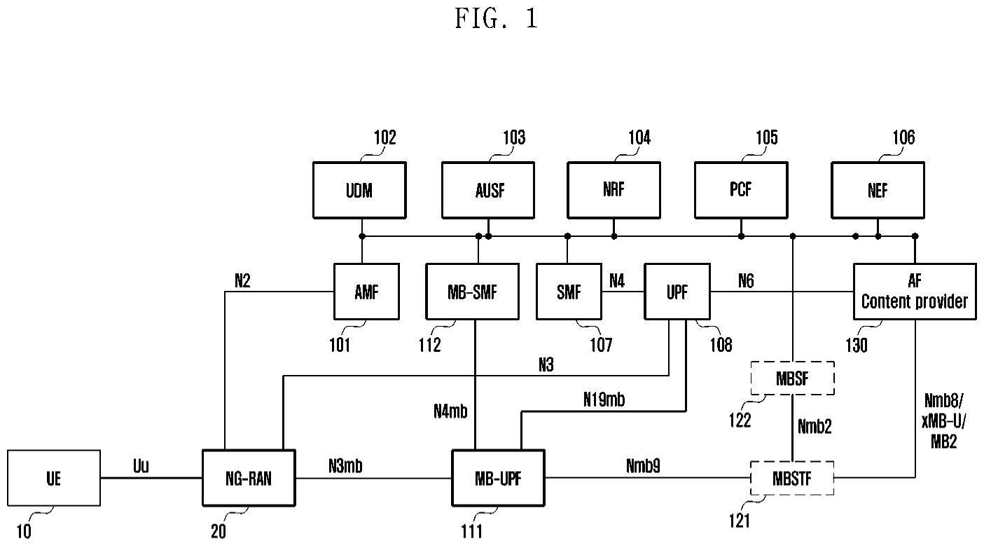

FIG. 1 illustrates the architecture of a cellular system for the MBS according to an embodiment of the disclosure.

With reference to FIG. 1, the cellular system may include user equipment (UE) 10, NG radio access network (NG-RAN) 20 being a base station, access and mobility management function (AMF) entity 101, multicast/broadcast user plane function (MB-UPF) entity 111, multicast/broadcast session management function (MB-SMF) entity 112, policy control function (PCF) entity 105, session management function (SMF) entity 107, network exposure function (NEF) entity 106, multicast/broadcast service function (MBSF) entity 122, multicast/broadcast service traffic function (MBSTF) entity 121, application function (AF) entity 130, unified data management (UDM) entity 102, user plane function (UPF) entity 108, authentication server function (AUSF) entity 103, and NF repository function (NRF) entity 104.

In describing FIG. 1, each network function (NF) of the 5GS will be described as “network function entity” or “network function”. However, those skilled in the art will understand that an NF and/or NF entity may be implemented on one or more specific servers, and that two or more NFs performing the same operation may be implemented on one server.

One NF or two or more NFs may be implemented in the form of a network slice in some cases. Such a network slice may be created based on a specific purpose. For example, a network slice may be configured to provide the same type of service, such as maximum data rate and data usage or guaranteed minimum data rate, to specific subscriber groups. In addition, network slices may be implemented according to various purposes. An additional description of the network slice will be omitted here.

Also, FIG. 1 illustrates interfaces between individual nodes. A Uu interface is used between the UE 10 and the NG-RAN 20, an N2 interface is used between the NG-RAN 20 and the AMF 101, an N3 interface is used between the NG-RAN 20 and the UPF 108, and an N3mb interface is used between the NG-RAN 20 and the MB-UPF 111. Additionally, an N4mb interface is used between the MB-UPF 111 and the MB-SMF 112, and an N19mb interface is used between the MB-UPF 111 and the UPF 108. An N4 interface is used between the SMF 107 and the UPF 108, an N6 interface is used between the UPF 108 and the AF 130, and an Nmb2 interface is used between the MBSF 122 and the MBSTF 121. An Nmb9 interface is used between the MB-UPF 111 and the MBSTF 121. Further, an Mmb8/xMB-U/MB2 interface is used between the AF 130 and the MBSTF 121.

Since these interfaces are defined in the NR standards, a further description will be omitted here.

In general, to support the MBS in the 5GS, a cellular system for the MBS may be composed of the following network function (NF) entities and services.

The AF 130 may be, for example, a V2X application server, a cellular Internet of things (CIoT) application server, a mission critical push-to-talk (MCPTT) application, a content provider, a TV or audio service provider, or a streaming video service provider.

To provide an MBS service, the AF 130 may make a request for MBS service provision to the MBSF 122, which is an NF that controls session management and traffic of the MBS service. The MBSF 122 may be an NF that receives an MBS service request from the AF 130, manages the corresponding MBS service session, and controls the corresponding MBS service traffic. Further, the MBSTF 121, as an NF that receives media from an AF providing an MBS under the control of the MBSF 122, an application server (AS) providing an MBS, or a contents provider, and handles media traffic, may function as an MBS service anchor within the 5GS.

Alternatively, in the 5GC, an MBS system may be configured to operate without including the MBSF 122 and MBSTF 121. If the MBSF 122 and MBSTF 121 are not included, the AF 130 may make an MBS service request to the MB-SMF 112 directly or through the NEF 106. In this case, MBS data is provided through the MB-UPF 111 to the 5G network from an application server (AS) providing the MBS or from a contents provider.

In the disclosure, the AF 130 may be an application server (AS) for providing a specific multicast/broadcast application service. Therefore, in the following description, it may be understood that the AS is the same as the AF 130 or that the AF 130 and the AS exist together. To provide an MBS service to the UE 10, the AF 130 may transmit a request to the MBSF 122 for providing the MBS service. Then, the MBSF 122 may control the MBSTF 121, which is an MBS service media anchor transferring MBS service traffic to the UE 10 in the 5GS, to provide the MBS service to the UE 10. Here, the MBS service may mean data corresponding to a multicast/broadcast service received from a specific contents provider.

Depending on the embodiment, the MBSF 122 and the MBSTF 121 may be integrated into one entity or one NF. As another example, the MBSF 122 may be configured to be integrated with the NEF 106 or another NF. As another example, the AF 130 may make an MBS service request directly to the MB-SMF 112 without the MBSF 122 or MBSTF 121 in the 5GS, and the MB-UPF 111 may receive media from a content provider being as AS or AF 130 and forward the corresponding traffic.

MBS service sessions are managed and service traffic is generated through the MBSF 122 and MBSTF 121; when service traffic is delivered to the UE 10 through multicast/broadcast, the traffic can be managed by allocating an MBS PDU session. That is, the MBSF 122 may correspond to a control plane that manages MBS sessions, and the MBSTF 121 may correspond to a user plane that handles traffic.

Meanwhile, in the following description, “multimedia broadcast-multicast service gateway-control plane (MBMS-GW-C) service” refers generically to a control function or service that creates an MBS context for an MBS PDU session, manages the MBS PDU session, and delivers traffic of the MBS PDU session to the NG-RAN 20 being a base station through IP multicast.

The MBMS-GW-C service may be configured as an SMF with MBS PDU session control by being integrated into an existing SMF that manages unicast PDU sessions, or may be configured as a separate NF. In the disclosure, the NF that supports the MBMS-GW-C service and also has the functionality of the existing SMF will be referred to as MB-SMF 112.

In addition, a service that delivers traffic received from the MB-UPF 111 according to the MBS context for the MBS PDU session through IP multicast to the NG-RAN 20 performing multicast/broadcast according to the MBMS-GW-C service will be referred to as multimedia broadcast-multicast service gateway-user plane (MBMS-GW-U) service.

The MBMS-GW-U service may be configured as a UPF with a capability of forwarding MBS traffic to an appropriate NG-RAN 20 via IP multicast by being integrated into an existing UPF that handles unicast PDU sessions, or may be configured as a separate NF as shown in FIG. 1. Therefore, in the following description, the NF that supports the MBMS-GW-U service and also has the functionality of the existing UPF will be referred to as MB-UPF 111.

In order for the MBMS-GW-C service to control the MBMS-GW-U service, the N4mb interface is used as described above.

In describing various embodiments of the disclosure, for convenience, MBMS-GW-C and MBMS-GW-U are mainly described as SMF and UPF, or MB-SMF 112 and MB-UPF 111, respectively, but if necessary, whether the purpose is for unicast only, multicast/broadcast only, or both will be described together to avoid confusion.

MBS traffic is delivered from the MBMS-GW-U (or, UPF or MB-UPF) to the NG-RAN 20. For example, it is delivered to the NG-RAN 20 by using IP multicast. Here, the tunnel between the MBMS-GW-U (or, UPF or MB-UPF) and the NG-RAN 20 is called a shared delivery tunnel or a shared N3 tunnel. In the following description, for convenience of description, it may be referred to as a shared delivery tunnel or shared tunnel.

To set up an M1 tunnel, the MBMS-GW-C (or, SMF or MB-SMF) can transmit a control message to the NG-RAN 20 through the AMF 101.

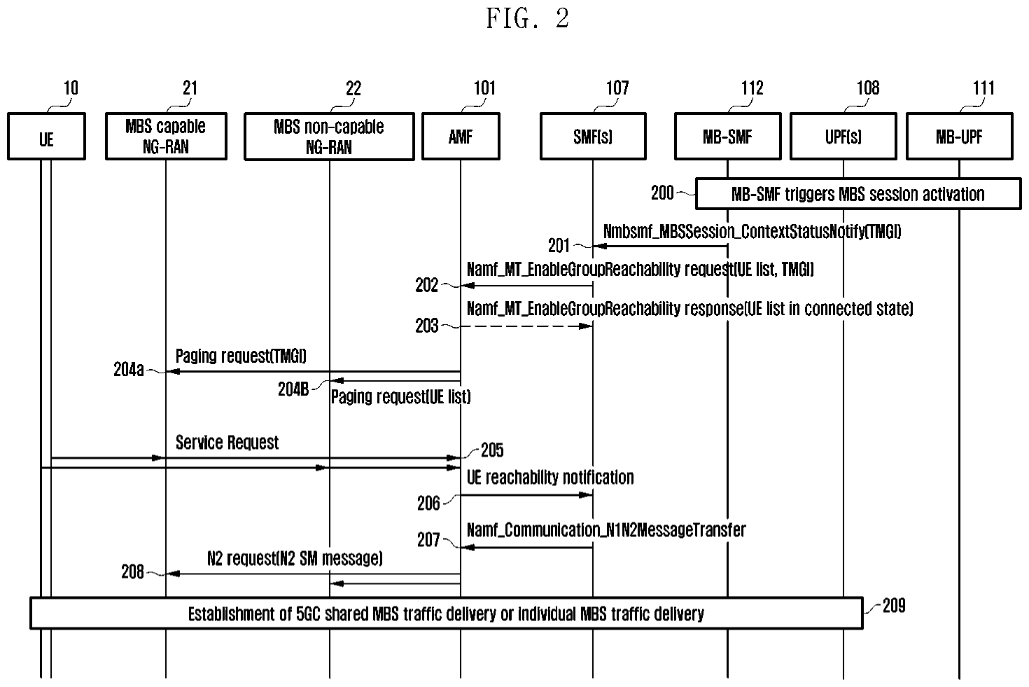

FIG. 2 is an example diagram depicting an existing procedure for waking up a UE in idle state in the process of activating a multicast session.

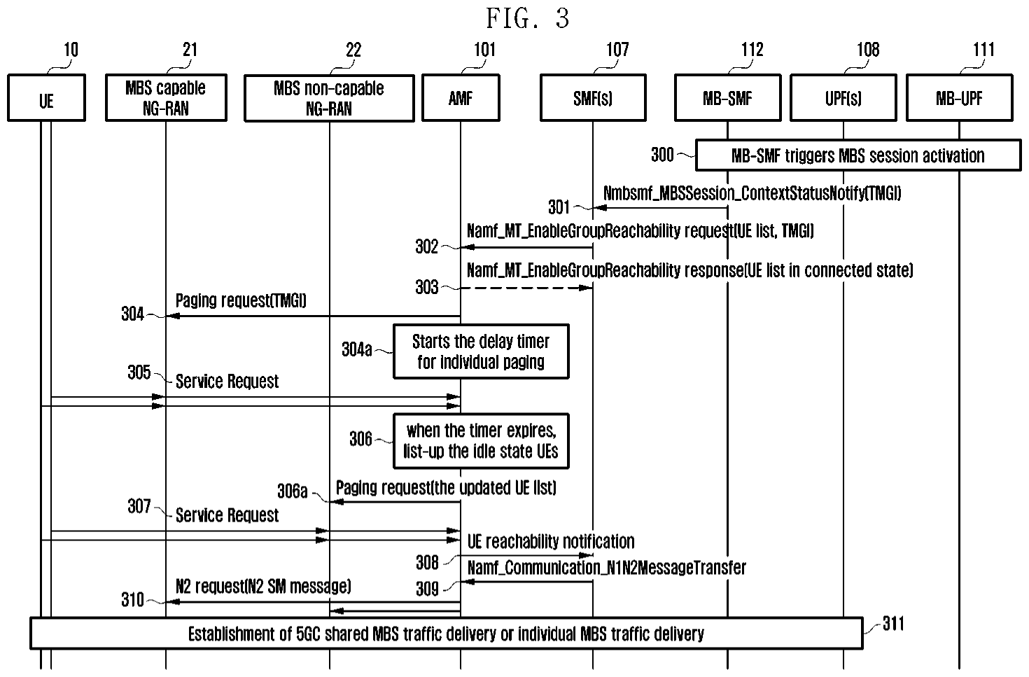

Before referring to FIG. 2, each component of FIG. 2 will be described using the components of the mobile communication network according to the disclosure described above in FIG. 1. However, the components of FIG. 1 may perform different operations according to the present disclosure, for example, operations below in FIG. 3 to be described later, but when describing FIG. 2, it should be noted that they are described as operating according to a legacy procedure for waking up a UE in idle state.

In the following description, UE 10, terminal, mobile terminal, etc. may be used interchangeably for the UE, but all may be understood as the UE 10 illustrated in FIG. 1. Further, in FIG. 2, in the description of the UE 10, the UE 10 may perform different operations according to the disclosure, for example, the operations below in FIG. 3 to be described later, but when describing FIG. 2, it should be noted that only operations according to the legacy procedure are described.

Meanwhile, in FIG. 2 and FIGS. 3 to 5 to be described later, an MBS capable base station 21 and a non-MBS capable base station 22 are distinguished, and both can be included in the NG-RAN 20. The meaning of an MBS capable base station 21 and a non-MBS capable base station 22 will become clearer through the following description.

With reference to FIG. 2, when the MB-SMF 112 receives a request from the AF 130 (not shown in FIG. 2) to activate the corresponding multicast session provided by the AF 130, or when the MB-SMF 112 receives a notification from the MB-UPF 111 that data for the corresponding multicast session provided by the AF 130 has occurred, at step 200, the MB-SMF 112 may initiate a procedure to activate the corresponding multicast session. At step 201, the MB-SMF 112 may transmit an MBS session context status notification (Nmbsmf_MBSSession_ContextStatusNotify) message to the SMFs 107 servicing the multicast session, thereby informing the SMF 107 that the multicast session needs to be activated. Here, the SMF 107 may be one SMF or multiple SMFs. For example, if MBS receiving UEs are present only in an area that can be managed by one SMF 107, it can be one SMF. On the other hand, if MBS receiving UEs are widely distributed in areas managed by multiple SMFs, there may be multiple SMFs. Hence, in the following description, it is assumed that MBS receiving UEs are widely distributed in areas managed by multiple SMFs.

When the MB-SMF 112 transmits a Nmbsmf_MBSSession_ContextStatusNotify message to the SMFs 107 servicing the multicast session at step 201, it may use a TMGI to identify a UE that requires multicast session activation. This TMGI be included in a Nmbsmf_MBSSession_ContextStatusNotify message or may be transmitted together with a Nmbsmf_MBSSession_ContextStatusNotify message. The SMF 107 having received the Nmbsmf_MBSSession_ContextStatusNotify message performs a process to wake up a UE in idle state so as to activate the multicast session. That is, at step 202, to wake up the UEs receiving the multicast session corresponding to the TMGI from the idle state, the SMF 107 may transmit a first request message, for example a Namf_MT_EnableGroupReachability request message, including a list of service receiving UEs and TMGI to the AMF 101 serving the corresponding UE. Here, the UE list may be a list of 5G globally unique subscription permanent identifier (5G-SUPI) values or 5G globally unique temporary identifier (5G-GUTI) values for UEs 10.

For a UE in connected state belonging to the UE list included in the received Namf_MT_EnableGroupReachability request message, at step 203, the AMF 101 may notify the SMF 107 of being in connected state. Additionally, since the AMF 101 may receive Namf_MT_EnableGroupReachability request messages from multiple SMFs 107, for UEs in connected state belonging to the UE lists received from multiple SMFs, the AMF 101 may notify the corresponding SMFs that the UEs are in connected state.

Meanwhile, at step 204, the AMF 101 may control paging to wake up a UE in idle state among the received UE list. First, in the following description, steps 204a and 204b will be collectively referred to as step 204. For example, the AMF 101 transmits a paging request message to a base station at a place corresponding to the paging area in the multicast service area. Here, the base station at a place corresponding to the paging area may be a base station including a UE in idle state.

To be more specific about step 204, the AMF 101 may transmit a paging request message including TMGI information to the MBS capable base station 21 (step 204a). Thereby, the MBS capable base station 21 may perform group paging according to TMGI information, allowing the UE utilizing the multicast service corresponding to the TMGI to recognize that it needs to wake up.

On the other hand, the AMF 101 may transmit a paging request message including a list of UEs in idle state (e.g., individual UE list or individual list) to the non-MBS capable base station 22 (step 204a). Here, the individual list of UEs in idle state may be composed using UE's 5G-GUTI values.

The base station 22 having received the individual UE list through step 204b may perform individual paging for each UE in the individual UE list. This allows the UE utilizing the multicast service included in the individual UE list to recognize that it needs to wake up. Here, when the AMF 101 transmits a list of UEs in idle state to the non-MBS capable base station 22, it may transmit a paging request message including a list of all UEs in idle state from among the list of UEs received from the SMF 107 to all non-MBS capable stations 22 present in the paging area.

In such a case, as described above, the number of UEs that need to be paged in a moment by the base station increases, which may lead to a shortage of paging resources or an increase in interference.

Meanwhile, a UE having recognized that it needs to wake up through group paging or individual paging may perform a service request procedure at step 205. In FIG. 2, the service request procedure may be a procedure in which the UE 10 transmits a service request message to the AMF 101 through the base station 21 or 22 having transmitted the paging. In FIG. 2, as described above, when the UE receives a group paging message from an MBS capable base station 21, it can transmit a service request message to the AMF 101 through the MBS capable base station 21. On the other hand, when the UE 10 receives an individual paging message from a non-MBS capable base station 22, it can transmit a service request message to the AMF 101 through the non-MBS capable base station 22.

Thereby, the AMF 101 having received service request messages through the MBS capable base station 21 and/or the non-MBS capable base station 22 may recognize that the UEs having transmitted the service request messages have woken up. Hence, the AMF 101 having received a service request message may transmit a list of woken-up UEs to the corresponding SMF 107 at step 206. Here, the list of woken-up UEs can be transmitted by using a reachability notification message.

The SMF 107 may activate the MBS session in response to the list of woken-up UEs. Thereafter, the SMF 107 may inform the AMF 101 that the multicast session is activated at step 207. Then, the AMF 101 transmits an N2 SM message to the corresponding base station to notify that the multicast session is activated at step 208. This N2 SM message may include a TMGI value, and resources for multicast services can be considered for the UEs servicing the multicast session corresponding to the TMGI. At step 209, a shared tunnel or individual tunnel may be set up between the base station 22 and the MB-UPF 108 to deliver multicast traffic.

FIG. 3 is a diagram illustrating a stepwise paging procedure as a method for waking up a UE in idle state in the process of activating a multicast session according to an embodiment of the disclosure.

Before referring to FIG. 3, each component of FIG. 3 will be described using the components of the mobile communication network according to the disclosure described above in FIG. 1. Each component illustrated in FIG. 3 may perform additional or alternative operations according to the disclosure in addition to the operations of the corresponding component described above in FIG. 2. Further, in the following description, UE 10, terminal, mobile terminal, etc. may be used interchangeably for the UE, but all may be understood as the UE 10 illustrated in FIG. 1.

With reference to FIG. 3, when the MB-SMF 112 receives a request from the AF 130 (not shown in FIG. 3) to activate the corresponding multicast session provided by the AF 130, or when the MB-SMF 112 receives a notification from the MB-UPF 111 that data for the corresponding multicast session provided by the AF 130 has occurred, at step 300, the MB-SMF 112 may initiate a procedure to activate the corresponding multicast session. At step 301, the MB-SMF 112 may transmit an MBS session context status notification (Nmbsmf_MBSSession_ContextStatusNotify) message to the SMFs 107 servicing the multicast session provided by the AF 130, thereby informing the SMF 107 that the multicast session needs to be activated. Here, a TMGI may be used to identify a UE that requires multicast session activation. This TMGI may be included in a Nmbsmf_MBSSession_ContextStatusNotify message or may be transmitted together with a Nmbsmf_MBSSession_ContextStatusNotify message. In addition, if MBS receiving UEs are present only in an area that can be managed by one SMF 107, there may be one SMF. On the other hand, if MBS receiving UEs are widely distributed in areas managed by multiple SMFs, there may be multiple SMFs. Hence, in the following description, it is assumed that MBS receiving UEs are widely distributed in areas managed by multiple SMFs. However, it will be apparent to those skilled in the art that the disclosure covers cases where there are MBS receiving UEs only in an area that can be managed by one SMF 107.

When the MB-SMF 112 transmits a Nmbsmf_MBSSession_ContextStatusNotify message to the SMFs 107 servicing the multicast session at step 301, it may use a TMGI to identify a UE that requires multicast session activation. This TMGI may be included in a Nmbsmf_MBSSession_ContextStatusNotify message or may be transmitted together with a Nmbsmf_MBSSession_ContextStatusNotify message. The SMF 107 having received the Nmbsmf_MBSSession_ContextStatusNotify message performs a process to wake up a UE in idle state (or transition it to active state) so as to activate the multicast session.

In the disclosure, the TMGI may be used for two purposes. First, a TMGI is information that identifies a session providing a multicast service and may be used as a multicast session ID or MBS session ID. Therefore, in the disclosure, a TMGI may be used as information for notifying a multicast session to be activated.

Second, a TMGI may be used as information for identifying a group of UEs that can receive a specific multicast service.

As described above, a TMGI may be included in a Nmbsmf_MBSSession_ContextStatusNotify message and notified to the SMFs as information for notifying the multicast session to be activated. Then, the SMF may initiate an operation to wake up UEs in idle state so that the UEs receiving the multicast session corresponding to the TMGI among the served UEs can receive the service, and may activate the multicast session by creating a tunnel for multicast sessions for a base station including a woken-up UE.

The SMF 107 may identify UEs that receive the MBS corresponding to the TMGI value. Then, at step 302, to wake up the UEs receiving the multicast session corresponding to the TMGI from the idle state, the SMF 107 may transmit a first request message, for example a Namf_MT_EnableGroupReachability request message, including a list of service receiving UEs and/or the TMGI to the AMF 101 serving the corresponding UE. Here, the UE list may be a list of SUPI values or 5G-GUTI values for UEs 10.

For a UE in connected state belonging to the UE list included in the received Namf_MT_EnableGroupReachability request message, at step 303, the AMF 101 may notify the SMF 107 of being in connected state. Additionally, since the AMF 101 may receive Namf_MT_EnableGroupReachability request messages from multiple SMFs 107, for UEs in connected state belonging to the UE lists received from multiple SMFs, the AMF 101 may notify the corresponding SMFs that the UEs are in connected state. As described above, steps 300 to 303 may be the same operations as those described at steps 200 to 203 in FIG. 2 above.

Meanwhile, according to the disclosure, for UEs in idle state, the AMF 101 may request MBS capable base stations 21 to perform paging to wake the UEs at step 304. For example, the AMF 101 may transmit a paging request message to MBS capable base stations 21 among base stations at a place corresponding to the paging area in the multicast service area. Here, the base station at a place corresponding to the paging area in the multicast service area may be a base station including a UE in idle state among multiple base stations providing multicast services. There may be one or more base stations including a UE in idle state, but a single base station is shown in FIG. 3 in consideration of the complexity of the drawing. However, even in the case of two or more base stations, all MBS capable base stations that receive a paging request message including a TMGI can operate in the same manner according to the base station operation shown in FIG. 3. In the following description, one base station will be used for description to represent a plurality of base stations.

As at step 304, the AMF 101 may transmit a paging request message including TMGI information to the MBS capable base station 21, enabling the MBS capable base station 21 to perform group paging according to the TMGI information. Hence, the MBS capable base station 21 may transmit a paging signal to the corresponding group of UEs by using the TMGI information included in the paging request message received at step 304 (transmission of a paging signal is not shown in the figure). That is, the MBS capable base station 21 transmits a paging signal, so that UEs using the multicast service corresponding to the TMGI can recognize that they need to wake up.

However, since the non-MBS capable base station 22 cannot handle TMGI information, paging must be requested based on an individual list of UEs in idle state. In other words, paging must be performed on all base stations in the paging area so that paging is performed to all UEs in the individual list of UEs in idle state. If the base station performs paging for all UEs, there is a high possibility that the base station will consume an extremely large amount of paging resources depending on the situation, as described above in FIG. 2.

Therefore, according to the disclosure, the AMF 101 may request paging in sequence for UEs included in the TMGI and UEs that need to be individually paged as at step 304a. That is, when the AMF 101 transmits a paging request message including TMGI information to MBS capable base stations 21 (step 304), it may start a timer for individual paging (step 304a). Steps 304 and 304a may be performed simultaneously, or step 304a may be performed immediately after step 304.

Meanwhile, when MBS capable base stations 21 pages to UEs according to the paging request message, the UEs having received paging for themselves may perform a process of waking up from the idle state by transmitting a service request message to the AMF 101 through the corresponding base station, as in step 305.

In FIG. 3, as in the case of a base station, one base station may include UEs corresponding to one or more TMGIs. The UE 10 shown in FIG. 3 has two different vertical lines to indicate multiple UEs. Hence, UEs corresponding to two or more TMGIs may each transmit a service request message to the base stations to which they belong. If two or more UEs are shown in FIG. 3, the drawing becomes very complicated, so it should be understood that this is for simplification.

The AMF 101 according to the disclosure does not transmit a paging request to the non-MBS capable base stations 22 until the timer for individual paging expires. Thereafter, at step 306, the AMF 101 may transmit a paging request message, which includes a list of UEs in idle state, for example, a portion of the 5G-GUTI list of UEs in idle state, to the non-MBS capable base stations 22. When the AMF 101 transmits a paging request message to the non-MBS capable base stations 22, it may make a partial list of UEs in idle state by randomly selecting some of the UEs in idle state. For example, the number of UEs in a list of UEs in idle state can be adjusted so as not to exceed the number of UEs that can be physically woken up through individual paging until the timer for individual paging expires (can be set in advance by the system or by the operator). Thereafter, when the timer for individual paging expires as at step 306, the AMF 101 may make a list of UEs in idle state that do not respond to the TMGI transmission and transmit a paging request message, which includes the newly made list of UEs in idle state, for example, a 5G-GUTI list of UEs in idle state, to the non-MBS capable base stations 22 again as at step 306a. Thereby, the non-MBS capable base stations 22 can perform individual paging to UEs in idle state.

Meanwhile, when the timer for individual paging expires, the AMF 101 may transmit again a paging request message including TMGI information to the MBS capable base stations 21 (not shown in FIG. 3).

In addition, a UE having recognized that it needs to wake up through group paging or individual paging may perform a service request procedure at step 307. In FIG. 3, the service request procedure may be a procedure in which the UE 10 transmits a service request message to the AMF 101 through the base station 21 or 22. In FIG. 3, as described above, when the UE receives a group paging message from an MBS capable base station 21, it can transmit a service request message to the AMF 101 through the MBS capable base station 21. On the other hand, when the UE 10 receives an individual paging message from a non-MBS capable base station 22, it can transmit a service request message to the AMF 101 through the non-MBS capable base station 22.

In addition, as described above, only one UE 10 is shown as a representative of MBS receiving UEs. Hence, there may be one or more UEs that respond to individual paging. In the case of two or more UEs, as illustrated in FIG. 3, each UE may transmit a service request message to the AMF 101 through the non-MBS capable base station 22 having transmitted a paging signal to the UE. Further, in FIG. 3, the UE that responds to group paging at step 305 and the UE that responds to individual paging at step 307 may be different UEs. If the drawing of FIG. 3 illustrates a UE responding to group paging and a UE responding to individual paging separately, the drawing becomes very complicated, so it should be noted that steps 305 and 307 are shown similarly for the sake of simplification.

Thereby, the AMF 101 having received service request messages through the MBS capable base station 21 and/or the non-MBS capable base station 22 may recognize that the UEs having transmitted the service request messages have woken up, and may transmit a list of woken-up UEs to the corresponding SMF 107 at step 308. Here, the list of woken-up UEs can be transmitted by using a reachability notification message.

The SMF 107 may set up a multicast session in response to the list of woken-up UEs, and it may inform the AMF 101 that the multicast session is activated at step 309. Upon recognizing that the multicast session for the MBS to be provided to the corresponding UEs is activated, the AMF 101 may transmit an N2 SM message to the corresponding base stations 21 and 22 to notify that the multicast session is activated at step 310. This N2 SM message includes a TMGI value, so that resources for multicast services can be considered for the UEs servicing the multicast session corresponding to the TMGI.

At step 311, a shared tunnel or individual tunnel may be set up between the UE 10 and the UPF 108 to deliver multicast traffic. A shared tunnel can be set up when the UE 10 uses an MBS capable station 21, and an individual tunnel can be set up when the UE 10 uses a non-MBS capable base station 22.

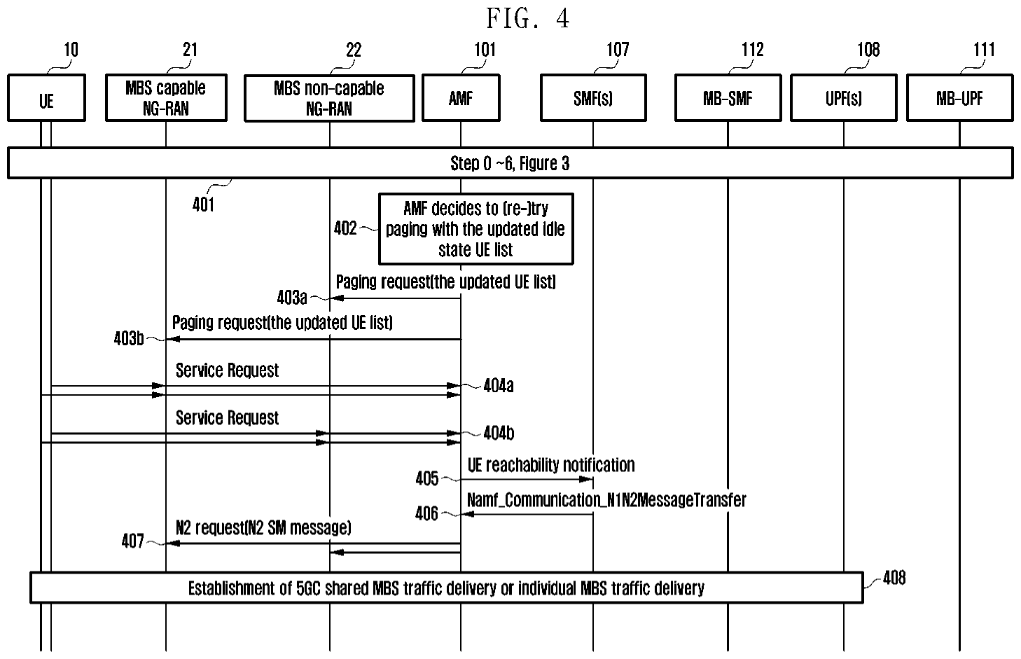

FIG. 4 is a diagram illustrating a procedure of retrying stepwise paging as a method of waking up a UE in idle state in the process of activating a multicast session according to an embodiment of the disclosure.

Before referring to FIG. 4, each component of FIG. 4 will be described using the components of the mobile communication network according to the disclosure described above in FIG. 1. Each component illustrated in FIG. 4 may perform additional or alternative operations according to the disclosure in addition to the operations of the corresponding component described above in FIG. 2. Further, in the following description, UE 10, terminal, mobile terminal, etc. may be used interchangeably for the UE, but all may be understood as the UE 10 illustrated in FIG. 1.

With reference to FIG. 4, step 401 may be the same as steps 300 to 306 of FIG. 3 described above. To briefly explain this again, the MB-SMF 112 may receive a request from an MBS providing AF 130 (not shown in FIG. 4) to activate the corresponding multicast session, or may receive a notification from the MB-UPF 111 that data for the corresponding multicast session has occurred. When the MB-SMF 112 initiates a procedure to activate the corresponding multicast session, it may transmit an Nmbsmf_MBSSession_ContextStatusNotify message including a TMGI to the AMF 107 through the SMFs 107, thereby informing the AMF 107 that the multicast session needs to be activated. That is, to allow UEs that receive a multicast session corresponding to the TMGI from the MB-SMF 112 to wake up from the idle state, the SMF 107 transmits a Namf_MT_EnableGroupReachability request message including a list of service receiving UEs and the TMGI to the AMF 101 serving the corresponding UEs to wake up the corresponding UEs. Here, the UE list may be a list of SUPI values or 5G-GUTI values for UEs. As described above, it is also assumed that there are multiple SMFs in FIG. 4. However, it will be apparent to those skilled in the art that the description of the disclosure can be applied even to a single SMF case. Additionally, the features of the TMGI described in FIG. 3 can be applied equally in FIG. 4.

Meanwhile, for a UE in idle state in the UE list, the AMF 101 may perform paging to wake up the UE. For example, the AMF 101 may transmit a paging request message to a base station in the multicast service area. As in FIG. 3 described above, the AMF 101 may transmit a paging request message including TMGI information to the MBS capable base stations 21. The MBS capable base stations 21 may perform group paging according to the TMGI information. Thereby, a UE using a multicast service corresponding to the TMGI may receive a paging signal to thereby recognize that it must wake up.

However, since non-MBS capable base stations 22 cannot handle TMGI information, they must individually request paging by using an individual list of UEs in idle state. Therefore, as described above, a problem in which individual paging suddenly increases may occur.

Hence, paging requests can be made in sequence to reduce paging resource consumption. That is, when the AMF 101 transmits a paging request message including TMGI information to MBS capable base stations, it can start a timer for individual paging. Thereafter, the AMF 101 may transmit a paging request message, which includes a list of UEs in idle state, for example, a portion of the 5G-GUTI list of UEs in idle state, to the non-MBS capable base stations 22, or the AMF 101 may not transmit a paging request to the non-MBS capable base stations 22 until the timer for individual paging expires. The AMF 101 may make a partial list of UEs in idle state to be included in the paging request message by randomly selecting some of the UEs in idle state. For example, the number of UEs in a list of UEs in idle state can be adjusted so as not to exceed the number of UEs that can be physically woken up through individual paging until the timer for individual paging expires. Meanwhile, when a base station pages UEs according to the paging request message, a UE having received paging for itself may perform a process of waking up from the idle state through a service request message.

Step 401 briefly described above may include the operations of steps 300 to 306 of FIG. 3 described above.

At step 402, when the timer for individual paging expires, that is, when the timer expires at step 306 of FIG. 3 described above and the list of UEs in idle state is updated, the AMF 101 may make a list of UEs that are still in idle state. Then, at step 402, the AMF 101 may determine to make a paging request again for UEs in the newly made list. Hence, at step 403a and step 403b, the AMF 101 may transmit a paging request message, which includes the newly made list of UEs in idle state, for example, a 5G-GUTI list of UEs in idle state, to all base stations 21 and 22 in the paging area. Accordingly, the base stations 21 and 22 can page UEs included in the 5G-GUTI list. Here, the AMF 101 may transmit a paging request message including a 5G-GUTI list not only to non-MBS capable base stations 22 but also to MBS capable base stations 21.

Meanwhile, a UE having recognized that it needs to wake up through paging may perform a service request procedure at step 404a or 404b. As described above, the service request procedure may be a procedure in which the UE 10 transmits a service request message to the AMF 101 through the base station 21 or 22. Hence, the UE 10 may transmit a service request message to the AMF 101 through the base station 21 or 22 to which it belongs.

Also in FIG. 4, as in FIG. 3 described above, UEs transmitting a service request message at step 404a are shown in separate vertical lines to indicate that they are different UEs. Therefore, from the same perspective as in FIG. 3, the service request messages transmitted at step 404a may be signals transmitted by different UEs. Step 404b may be understood the same as step 404a. In addition, the UE on the first one of the vertical lines at step 404a and the UE on the first one of the vertical lines at step 404b may be different UEs. That is, the UE corresponding to the first one of the vertical lines at step 404a is a UE that is located within the MBS capable base station 21 and has received a paging signal from the MBS capable base station 21. On the other hand, the UE corresponding to the first one of the vertical lines at step 404b is a UE that is located within the non-MBS capable base station 22 and has received a paging signal from the MBS capable base station 21. This can equally be applied to the second vertical line for the UE. It should be noted that since it is difficult to represent UEs in an MBS capable base station and UEs in a non-MBS capable base station in a distinguished manner in one drawing, the configuration of FIG. 4 is shown in this way to indicate that the UE 10 is a representative of those UEs.

The AMF 101 having received service request messages at step 404a or 404b may recognize that the UEs having transmitted the service request messages have woken up, and may transmit a list of woken-up UEs to the corresponding SMF 107 at step 405. The SMF 107 may inform the AMF 101 that the multicast session is activated at step 406. Then, the AMF 101 may transmit an N2 SM message to the corresponding base station to notify that the multicast session is activated at step 407. This N2 SM message may include a TMGI value, and resources for multicast services can be considered for the UEs servicing the multicast session corresponding to the TMGI. At step 408, a shared tunnel or individual tunnel may be set up between the UE 10 and the UPF 108 to deliver multicast traffic. A shared tunnel can be set up when the UE 10 uses an MBS capable station 21, and an individual tunnel can be set up when the UE 10 uses a non-MBS capable base station 22.

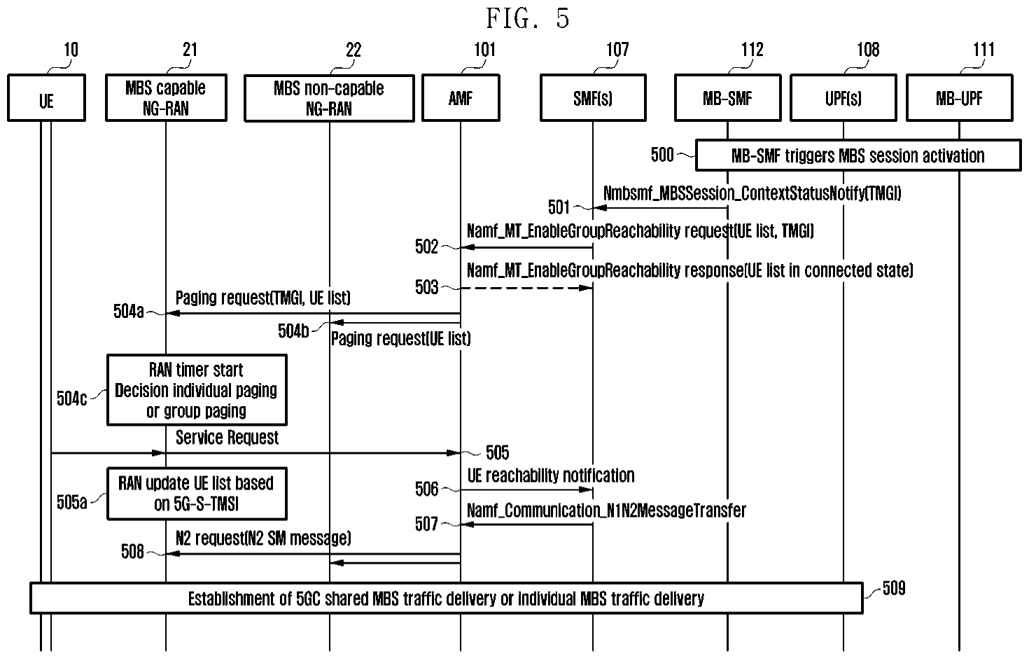

FIG. 5 is an example diagram illustrating a procedure of determining a paging scheme in the RAN as a method of waking up a UE in idle state in the process of activating a multicast session according to an embodiment of the disclosure.

Before referring to FIG. 5, each component of FIG. 5 will be described using the components of the mobile communication network according to the disclosure described above in FIG. 1. Each component illustrated in FIG. 5 may perform additional or alternative operations according to the disclosure in addition to the operations of the corresponding component described above in FIG. 2. Further, in the following description, UE 10, terminal, mobile terminal, etc. may be used interchangeably for the UE, but all may be understood as the UE 10 illustrated in FIG. 1.

With reference to FIG. 5, when the MB-SMF 112 receives a request from an AF 130 (not shown in FIG. 5) to activate the corresponding multicast session provided by the AF 130, or when the MB-SMF 112 receives a notification from the MB-UPF 111 that data for the multicast session provided by the AF 130 has occurred, at step 500, the MB-SMF 112 may initiate a procedure to activate the corresponding multicast session. At step 501, the MB-SMF 112 may transmit an MBS session context status notification (Nmbsmf_MBSSession_ContextStatusNotify) message to the SMFs 107 servicing the multicast session provided by the AF 130 so as to notify that the multicast session needs to be activated. Here, a TMGI may be used to identify a UE that requires multicast session activation, and this TMGI may be included in a Nmbsmf_MBSSession_ContextStatusNotify message or may be transmitted together with a Nmbsmf_MBSSession_ContextStatusNotify message. Additionally, the features of the TMGI described in FIG. 3 can be equally applied to FIG. 4.

The SMF 107 having received the Nmbsmf_MBSSession_ContextStatusNotify message may perform a process to wake up a UE in idle state (or transition it to active state) so as to activate the multicast session. That is, at step 502, to wake up the UEs receiving the multicast session corresponding to the TMGI from the idle state, the SMF 107 may transmit a first request message, for example a Namf_MT_EnableGroupReachability request message, including a list of service receiving UEs and/or the TMGI to the AMF 101 serving the corresponding UE. Here, the UE list may be a list of SUPI values or 5G-GUTI values for UEs 10. For a UE in connected state belonging to the UE list, at step 503, the AMF 101 may notify the SMF 107 of being in connected state.

Meanwhile, for a UE in idle state belonging to the UE list, the AMF 101 may request the base station to perform paging to wake up the UE at steps 504a and 504b. For example, the AMF 101 may transmit a paging request message to a base station at a place in the paging area in the multicast service area. The AMF 101 may separately make a paging request to an MBS capable base station and a non-MBS capable base station as at steps 504a and 504b. To be more specific with an example, at step 504a, the AMF 101 may transmit a paging request message including TMGI information and a list of UEs in idle state (e.g., 5G-GUTI list of UEs in idle state) to the MBS capable base stations 21. In addition, at step 504b, the AMF 101 may transmit a paging request message including a partial list of UEs in idle state (e.g., a portion of a 5G-GUTI list of UEs in idle state) to the non-MBS capable base stations 22. Thereby, the AMF 101 may enable individual base stations to perform paging.

In particular, the MBS capable base station 21 having received a paging request message including TMGI information and a list of UEs in idle state, may determine whether to perform group paging based on the TMGI or individual paging based on the 5G-GUTI at step 504c. For example, the MBS capable base station 21 may determine this at step 504c in consideration of the number of UEs in idle state or the other. To explain this with an example, when the MBS capable base station 21 receives a paging request, it first performs group paging based on the TMGI and starts a RAN timer. Thereafter, when the time set in the RAN timer expires, individual paging can be performed if the number of UEs in idle state is less than a given number.

Meanwhile, when base stations page UEs according to the paging request, a UE having received paging for itself may perform a process of waking up from the idle state by transmitting a service request message to the AMF 101 through the base station having transmitted the paging signal at step 505. When the UE accesses the base station to transmit a service request message as in step 505, the UE may use a 5G-S-TMSI value based on the 5G-GUTI in the random access procedure (RACH procedure); then, at step 505a, the base station may recognize that the corresponding UE has woken up from the idle state, and may update the 5G-GUTI list of UEs in idle state correspondingly, such as excluding the corresponding UE from the list of UEs in idle state.

Meanwhile, FIG. 5 also shows two vertical lines for the UE. This is to depict two or more UEs. However, it should be noted that FIG. 5 illustrates a case where only one UE among two or more UEs corresponds to the TMGI and transmits a service request message to the MBS capable base station 21.

Additionally, the base station may perform or attempt to perform group paging and individual paging based on the updated 5G-GUTI list of UEs in idle state (not shown in the drawing).

The AMF 101 having received service request messages may recognize that the UEs having transmitted the service request messages have woken up, and may transmit a list of woken-up UEs to the corresponding SMF 107 at step 506. The SMF 107 may inform the AMF 101 that the multicast session is activated. The AMF 101 having recognized that the multicast session for the MBS to be provided to the corresponding UE is activated may transmit an N2 SM message to the corresponding base station to notify that the multicast session is activated at step 508. This N2 SM message may include a TMGI value, and resources for multicast services can be considered for the UEs servicing the multicast session corresponding to the TMGI. At step 509, a shared tunnel or individual tunnel may be set up between the UE 10 and the UPF 108 to deliver multicast traffic. A shared tunnel can be set up when the UE 10 uses an MBS capable station 21, and an individual tunnel can be set up when the UE 10 uses a non-MBS capable base station 22.

As mentioned in all embodiments of the disclosure described above, to enable UEs receiving a multicast session corresponding to a TMGI to wake up from the idle state, the SMF can wake up the corresponding UEs by transmitting a Namf_MT_EnableGroupReachability request message including a list of service receiving UEs and the TMGI to the AMF serving the corresponding UEs.

In this case, there may be multiple SMFs servicing a single specific multicast session. Hence, those SMFs servicing one specific multicast session will have different lists of UEs receiving the service through the TMGI. Therefore, the AMF having received the request needs to collect the UE lists by receive all Namf_MT_EnableGroupReachability request messages from the SMFs servicing the same multicast session. To this end, when the AMF receives a Namf_MT_EnableGroupReachability request message from a specific SMF for one TMGI, it may start a waiting timer and receive Namf_MT_Enable GroupReachability request messages from SMFs until the waiting timer expires so as to collect lists of UEs in idle state for the TMGI included in the request messages. Then, based on these collected UE lists, the AMF can make a paging request to the base stations in the paging area according to the method of each embodiment.

In another method, without collecting UE lists from individual SMFs, as soon as the AMF receives a Namf_MT_EnableGroupReachability request message, for the TMGI and UE list included in the received request message, it can make a paging request to the base stations in the paging area according to the method of each embodiment. However, to prevent repeated transmission of a paging request for the same TMGI to base stations, when transmitting a paging request message to base stations, the AMF may omit additional transmission of the paging request message for the TMGI if a paging request for the same TMGI has already been made to the same base station.

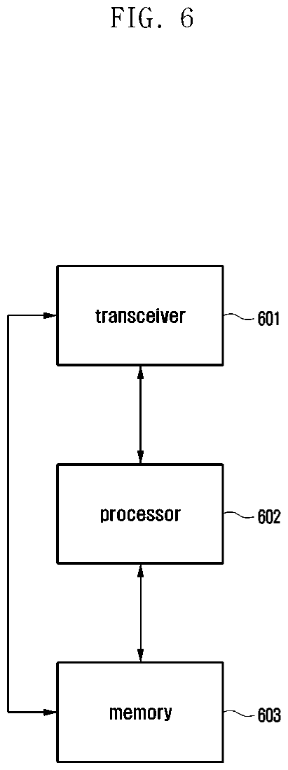

FIG. 6 is a block diagram of a UE according to an embodiment of the disclosure.

With reference to FIG. 6, the UE 10 may include a transceiver 601, a processor 602, and a memory 603. The transceiver 601 may include a wireless communication module, a modem, and/or a communication processor to enable communication with cellular systems such as LTE, LTE-A, 5G networks. FIG. 6 illustrates only essential components according to the disclosure, and although not illustrated in FIG. 6, a display, an input means or the other may be included for an interface with the user. In addition, the UE 10 may include various additional components such as a camera module and sensor module.

The processor 602 can be implemented with one or more processors, and can perform overall control of the UE 10. For example, the processor 602 may connect or disconnect a call according to a user's request, and may receive an MBS and provide it to the user according to the disclosure. Additionally, the processor 602 may control operations for transitioning to the idle state for a specific reason while receiving an MBS, and waking-up in response to paging according to the present disclosure. In addition, the processor 602 can perform control to provide a customized service to the user.

The memory 603 may include a region for storing various control information needed for the UE 10 and a region for storing user data. The region for storing control information may include control data for receiving an MBS, control data for transitioning to the idle state, and control data for performing operations based on paging reception.

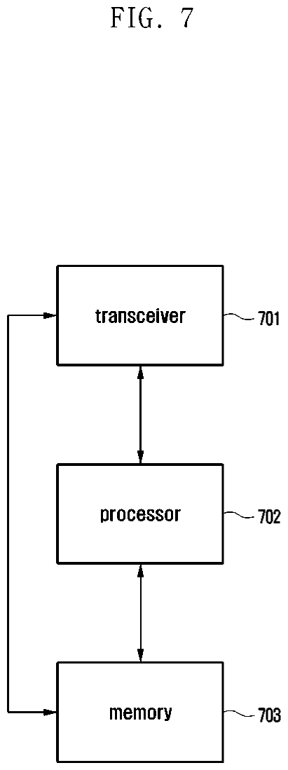

FIG. 7 is a block diagram of an NF according to an embodiment of the disclosure.

With reference to FIG. 7, the NF may include a transceiver 701, a processor 702, and a memory 703. In addition, other additional components may be included if necessary. For example, it may include an interface for operator's access, and an interface for providing operational situations to the operator. In this disclosure, no special restrictions are placed on the additional components of the NF.

The transceiver 701 may be configured to be connected to the processor 702, and may provide an interface for communication with another NF. For example, if the NF is an AMF, an interface for communicating with a RAN and SMF may be provided. As another example, if the NF is an SMF, an interface for exchanging various data/signals/messages with an AMF and/or MB-SMF may be provided. Further, in the case of a RAN, the transceiver 701 may include a radio interface for communicating with the UE 10 through a radio channel, and it may provide an interface for communicating with the AMF.

The processor 702 may be composed of one or more processors. The processor 702 may control the operation of the corresponding NF described in the disclosure. For example, if the NF is an AMF, the processor 702 may control operations of the AMF among the operations according to FIGS. 2 to 5 described above. As another example, if the NF is an SMF, the processor 702 may control operations of the SMF among the operations according to FIGS. 2 to 5 described above. Further, if the NF is a RAN, the processor 702 may control operations of the RAN among the operations according to FIGS. 2 to 5 described above.

The memory 703 may be configured to be connected to the processor 702 and may be connected to the transceiver 701. The memory 703 may store information for controlling the NF, information generated during control, and information necessary according to the disclosure.

Meanwhile, specific embodiments have been described in the detailed description of the disclosure, but various modifications are possible without departing from the scope of the disclosure. Therefore, the scope of the disclosure should not be limited to those embodiments described above, but should be determined by the appended claims and their equivalents.

### INDUSTRIAL APPLICABILITY

The disclosure can be used in the electronics industry and the information and communication industry.

1. An operation method of an access and management function (AMF) entity for waking up terminals to activate a multicast/broadcast service (MBS) session in a mobile communication system, the method comprising:
receiving a request message, which includes a list of terminals in idle state and a temporary mobile terminal group identity (TMGI) and requests waking-up of the terminals in idle state, from a session management function (SMF) entity;
transmitting a first paging request message including the TMGI to at least one MBS capable base station;
starting a delay timer for individual paging;
receiving a first service request message from at least one of the terminals in idle state via the at least one MBS capable base station;
updating the list of terminals in idle state by excluding a terminal having transmitted the first service request message; and
transmitting a second paging request message including at least a portion of the updated list of terminals in idle state to at least one non-MBS capable base station.

2. The operation method of claim 1, wherein the list of terminals in idle state is updated when the delay timer expires.

3. The operation method of claim 1, further comprising receiving a second service request message from at least one of the terminals in idle state via the at least one non-MBS capable base station.

4. The operation method of claim 3, further comprising transmitting a notification message including a list of woken-up terminals among the terminals in idle state to the SMF entity on the basis of the first service request message and the second service request message.

5. The operation method of claim 4, further comprising receiving a message notifying that the MBS session is activated from the SMF entity in response to the notification message.

6. An operation method of an access and management function (AMF) entity for waking up terminals to activate a multicast/broadcast service (MBS) session in a mobile communication system, the method comprising:
receiving a request message, which includes a list of terminals in idle state and a temporary mobile terminal group identity (TMGI) and requests waking-up of the terminals in idle state, from a session management function (SMF) entity;
transmitting a first paging request message including the TMGI to at least one MBS capable base station;
starting a delay timer for individual paging;
receiving a first service request message from at least one of the terminals in idle state via the at least one MBS capable base station;
updating the list of terminals in idle state by excluding a terminal having transmitted the first service request message;
transmitting a second paging request message to the at least one MBS capable base station based on the updated list so as to wake up a terminal not having transmitted the first service request message; and
transmitting a third paging request message including at least a portion of the updated list of terminals in idle state to at least one non-MBS capable base station.

7. The operation method of claim 6, further comprising receiving a second service request message from at least one of terminals not having transmitted the first service request message via the at least one non-MBS capable base station.

8. The operation method of claim 7, further comprising receiving a third service request message from at least one of the terminals in idle state via the at least one non-MBS capable base station.

9. The operation method of claim 8, further comprising transmitting a notification message including a list of woken-up terminals among the terminals in idle state to the SMF entity on the basis of the first service request message, the second service request message, and the third service request message.

10. The operation method of claim 9, further comprising receiving a message notifying that the MBS session is activated from the SMF entity in response to the notification message.

11. An operation method of a base station for waking up terminals to activate a multicast/broadcast service (MBS) session in a mobile communication system, the method comprising:
receiving a request message, which includes a list of terminals in idle state and a temporary mobile terminal group identity (TMGI) and requests waking-up of the terminals in idle state, from an access and management function (AMF) entity of the mobile communication system;
transmitting a first group paging message to at least one of the terminals in idle state on the basis of the TMGI;
starting a delay timer for individual paging;
transmitting a first individual paging message to at least one of the terminals in idle state on the basis of the list of terminals in idle state;
receiving a first service request message from at least one of the terminals in idle state; and
updating the list of terminals in idle state by excluding a terminal having transmitted the first service request message.

12. The operation method of claim 11, wherein the list of terminals in idle state is updated when the delay timer expires.

13. The operation method of claim 11, further comprising transmitting a second group paging message or a second individual paging message to terminals not having transmitted the first service request message on the basis of the updated list so as to wake up the terminals not having transmitted the first service request message.

14. The operation method of claim 13, further comprising receiving a second service request message from at least one of the terminals not having transmitted the first service request message.

15. The operation method of claim 11, further comprising transmitting a notification message including a list of woken-up terminals among the terminals in idle state to the AMF entity on the basis of the first service request message.
